(19) United States
(12) Patent Application Publication
(10) Pub. No.: US 2005/0058172 A1
(43) Pub. Date: Mar. 17, 2005

(54) System and method for segmented electrode with temporal voltage shifting

(76) Inventors: Rainer Paetzel, Dransfeld (DE); Igor Bragin, Goettingen (DE); Andreas Targsdorf, Gardelegen (DE); Vadim Berger, Goettingen (DE); Rustem Osmanow, Rosdorf (DE)

Correspondence Address: STALLMAN & POLLOCK LLP, SUITE 2200, 353 SACRAMENTO STREET, SAN FRANCISCO, CA, 94111, US

(21) Appl. No.: 10/936,084

(22) Filed: Sep. 8, 2004

Related U.S. Application Data
(60) Provisional application No. 60/502,073, filed on Sep. 11, 2003.

(51) Int. Cl. H01S 3/00; H01S 3/22

(52) U.S. Cl. 372/55; 372/38.07

(57) ABSTRACT

The stability of a gas discharge in an excimer or molecular fluorine laser system can be improved by generating multiple discharge pulses in the resonator chamber, instead of a single discharge pulse. Each of these discharges can be optimized in both energy transfer and efficient coupling to the gas. The timing of each discharge can be controlled using, for example, a common pulser component along with appropriate circuitry to provide energy pulses to each of a plurality of segmented main discharge electrodes. Applying the energy to the segmented electrodes rather than to a standard discharge electrode pair allows for an optimization of the temporal shape of the resulting superimposed laser pulse. The optimized shape and higher stability can allow the laser system to operate at higher repetition rates, while minimizing the damage to system and/or downstream optics.

### CLAIM OF PRIORITY

The present application claims benefit from U.S. Provisional Patent Application Ser. No. 60/502,073, filed Sep. 11, 2003, which is incorporated herein by reference.

### TECHNICAL FIELD OF THE INVENTION

The present invention relates to an excimer or molecular fluorine laser system.

### BACKGROUND

Semiconductor manufacturers are currently using deep ultraviolet (DUV) lithography tools based on KrF-excimer laser systems, operating at wavelengths around 248 nm, as well as ArF-excimer laser systems, which operate at around 193 nm. Vacuum UV (VUV) tools are based on F₂-laser systems operating at around 157 nm. These relatively short wavelengths are advantageous for photolithography applications because the critical dimension, which represents the smallest resolvable feature size that can be produced photolithographically, is proportional to the wavelength used to produce that feature. The use of smaller wavelengths can provide for the manufacture of smaller and faster microprocessors, as well as larger capacity DRAMs, in a smaller package. In addition to having smaller wavelengths, such lasers have a relatively high photon energy (i.e., 7.9 eV) which is readily absorbed by high band gap materials such as quartz, synthetic quartz (SiO₂), Teflon (PTFE), and silicone, among others. This absorption leads to excimer and molecular fluorine lasers having even greater potential in a wide variety of materials processing applications. Excimer and molecular fluorine lasers having higher energy, stability, and efficiency are being developed as lithographic exposure tools for producing very small structures as chip manufacturing proceeds into the 0.18 micron regime and beyond. The desire for such submicron features comes with a price, however, as there is a need for improved processing equipment capable of consistently and reliably generating such features. Further, as excimer laser systems are the next generation to be used for micro-lithography applications, the demand of semiconductor manufacturers for powers of 40 W or more to support throughput requirements leads to further complexity and expense.

In laser systems used for photolithography applications, for example, it would be desirable to move toward higher repetition rates, increased energy stability and dose control, increased system uptime, narrower output emission bandwidths, improved wavelength and bandwidth accuracy, and improved compatibility with stepper/scanner imaging systems. It also would be desirable to provide lithography light sources that deliver high spectral purity and extreme power, but that also deliver a low cost chip production. Requirements of semiconductor manufacturers for higher power and tighter bandwidth can place excessive, and often competing, demands on current single-chamber-based light sources.

Excimer and molecular fluorine lasers typically utilize a fast avalanche gas discharge to excite the laser gas. A discharge voltage on the order of 20-40 kV typically is delivered to a peaking capacitor of a solid state pulser module, which then delivers a breakdown voltage to the main discharge electrodes that is sufficient to properly excite the gas. In order to optimize the efficiency of this energy transfer, the impedance of the discharge circuit is matched with the relatively low impedance of the gas. The typical voltage pulse applied to the main electrodes shows a rise time of about 20 ns, with a pulse duration of about 50 ns. The solid state pulser module transforms the charging voltage to the required voltage range, and compresses the pulse to obtain the necessary fast rise time at the electrodes.

FIG. 1 shows a schematic of an existing laser system 100 utilizing such a solid state pulser module 102. A pulse compression circuit of the laser system is shown, which includes a pulser module 102 and at least one final compression stage 120. The pulser module is connected to receive a high voltage from a power supply 104, which can be constructed from one or more power supplies connected in parallel, such as in a “master-slave” configuration, which can provide the voltage and charge for the laser pulse within the required time, such as between the consecutive pulses. Such a power supply can be obtained from Lambda EMI of Neptune, N.J., where model LC203 has been tested in pulsed operation up to 6 kHz. A storage capacitor 106 of the pulser module can hold the charge until a trigger pulse is received and the IGBT (Insulated gate, bi-polar transistor) 108 switches the stored energy into a primary winding of transformer 110. A magnetic assist inductor 112 can be used in a primary loop of the transformer to control current risetime. The signal can be transformed with suitable step-up ratio of about 20, for example, and can charge capacitor 114. A saturable inductor 116 can hold off this voltage, preventing charging of capacitor 118 until a hold-off time is reached, whereby a compressed current pulse charges capacitor 118. In this manner, these components form a pulse compression stage in the pulser module 102. Depending on the specific design requirements, additional pulse compression stages can be added to further modify the electrical pulse output by the common pulser. For example, the electrical pulse from the pulser module can be input into a final compression stage 120 of the pulse compression circuit, which can further modify the electrical pulse input to the gas discharge unit 122. During the transfer of the pulse through the final compression stage, each pulse can be further compressed to show a fast risetime of about 50 ns on the peaking capacitors 124. In operation the chamber can generate a relatively lower power output beam as a result of electrical charge stored on the peaking capacitor 124 being discharged through the electrodes 126 of gas discharge unit 122. In operation it is desirable to be able to precisely control the timing of the electrical pulse being discharged in the gas discharge unit 122. A trigger signal can be applied to a system processor, which can determine a delay between receiving the trigger signal and toggling the IGBT switch 108. In response to the closing of the IGBT switch, an electrical pulse is output through the compression stages of the common pulser 102 to final compression stage 120. The pulser module can include a reset current unit 128 that can apply a reset current to inductors or magnetic switches of the pulser, providing some control over the timing and shape of the electrical pulse output by the pulser module 102. The gas discharge unit 122 can further include a photodetector or other mechanism for generating a signal to indicate the time at which a discharge or light pulse occurs in the discharge unit. It should be noted that different types of devices or circuits can be used to detect a discharge, such as a pick off loop or other electrical sensor, to detect the actual discharge from the peaking capacitor. Such a sensor can be used to detect the discharge of the peaking capacitor and/or the emission of a light pulse from the master oscillator. Based on the timing information, the microprocessor can use reset current module 128 to provide reset current to inductors of the final compression stage 120 to adjust the timing of the discharge in the gas discharge unit. In addition to using a reset current controller to control the timing of pulses reaching the discharge unit, the timing of the preionization of gases in the discharge chamber also can be controlled. By controlling this preionization of the gases, the precise timing of the actual discharges between the electrodes of each chamber can be further controlled.

In a standard excimer laser gas discharge using a circuit such as shown in FIG. 1, the energy coupling is obtained by applying a single high voltage pulse to the pair of main discharge electrodes 126 of the laser. The voltage rise-time and impedance matching requirements will determine the temporal shape of this voltage pulse. Certain applications may require a more optimal temporal shape of the pulse, such as a shape that is longer, has a lower peak value, and/or is substantially more uniform at the peak. Certain applications also may require a more stable gas discharge than is obtainable with such a system, which allows for operation at higher repetition rates.

### BRIEF DESCRIPTION OF THE DRAWINGS

FIG. 1 shows a schematic diagram of a laser system of the prior art using a solid state pulser with standard electrodes.

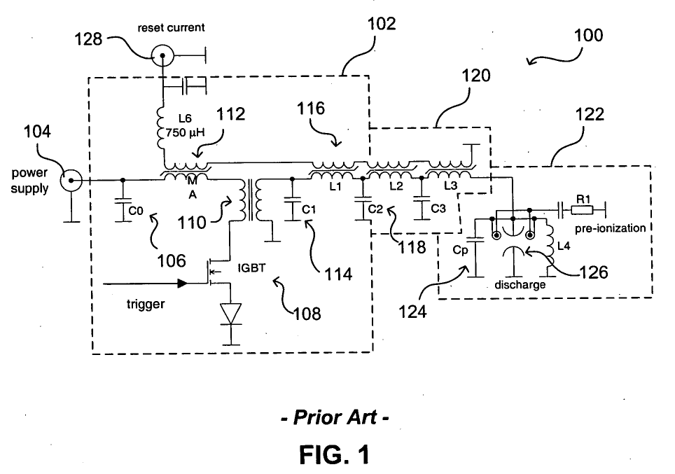

FIG. 2 shows a schematic diagram of a laser discharge circuit using a segmented electrode in accordance with one embodiment of the present invention.

FIG. 3 shows a schematic diagram of a laser discharge circuit using a segmented electrode in accordance with another embodiment of the present invention.

FIG. 4 shows a schematic diagram of a laser discharge circuit using a segmented electrode in accordance with another embodiment of the present invention.

FIG. 5 is a plot showing voltage curves for two pulses of a segmented electrode system in accordance with one embodiment of the present invention.

FIG. 6 is a plot showing a superimposition of two pulses of a segmented electrode system in accordance with one embodiment of the present invention.

FIG. 7 shows a schematic diagram of a laser discharge circuit using a segmented electrode in accordance with another embodiment of the present invention.

FIGS. 8(a)-(c) show schematic views of several electrode arrangements that can be used in accordance with various embodiments of the present invention.

FIG. 9 shows a schematic diagram of a laser system in accordance with another embodiment of the present invention.

FIG. 10 shows a B-H curve for a magnetic core that can be used in accordance with various embodiments of the present invention.

FIG. 11 shows a schematic diagram of a laser system in accordance with another embodiment of the present invention.

FIG. 12 shows a single chamber MOPA system that can be used in accordance with one embodiment of the present invention.

FIG. 13 shows a single chamber MOPA system that can be used in accordance with another embodiment of the present invention.

FIG. 14 shows a plasma cathode arrangement that can be used in accordance with one embodiment of the present invention.

### DETAILED DESCRIPTION

Systems and methods in accordance with embodiments of the present invention can overcome deficiencies in existing excimer and molecular fluorine laser systems by changing the way in which voltage is applied to the discharge electrodes. An improved discharge can help to optimize the temporal shape of the discharge pulse, such as to provide a pulse that is longer, has a lower peak value, and/or is substantially more uniform at the peak.

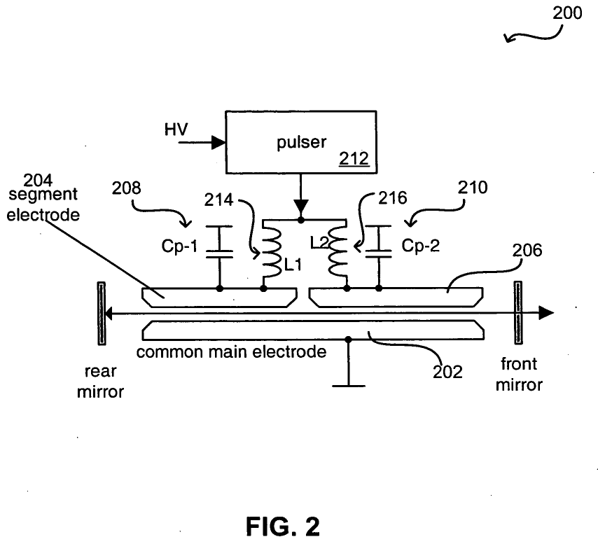

FIG. 2 shows a laser system 200 in accordance with one embodiment, wherein one of the main discharge electrodes, here the anode, is separated into (at least) two segments 204, 206 while the other main electrode 202, here the grounded cathode, remains unsegmented. In alternative embodiments, only the cathode and/or both main discharge electrodes (e.g., the anode and cathode) can be segmented as will be discussed elsewhere herein. The use of segmented electrodes can allow for multiple discharges within a single laser medium. Each of these discharges can be optimized in both energy transfer and efficient coupling to the gas. The separation of the electrode segments also allows for control over the relative timing of each discharge. Both anode segments 204, 206 are shown to be connected to a respective set 208, 210 of peaking capacitors. The solid state pulser module 212 provides a single output, which can be coupled via respective inductors 214, 216 to the separate discharge capacitors 208, 210 having a total capacitance in this embodiment on the order of about 4-8 nF. As a result the output of the pulser module is split into at least two paths, one for each electrode segment 204, 206. The timing of the discharge of each electrode segment, and any delay therebetween, can be controlled through selection of the corresponding inductors 214, 216. When the inductors have approximately the same inductance values, such as an inductance value of approximately 200 nH, the discharge of each capacitor segment will occur almost simultaneously. As the difference in inductance between the inductors changes, such as with inductor 216 having an inductance value of up to about 100 nH greater than the inductance value of inductor 214, the delay between discharges will increase/decrease accordingly. A proper combination of capacitor and inductor values can be used to obtain a desired time shift of the individual discharges for each electrode segment, such as a timing delay of 10 ns-30 ns, leading to a stretching of the overall pulse. The use of separate discharges each having a relatively low peak power with respect to a single discharge also can result in this longer pulse having a reduced peak power.

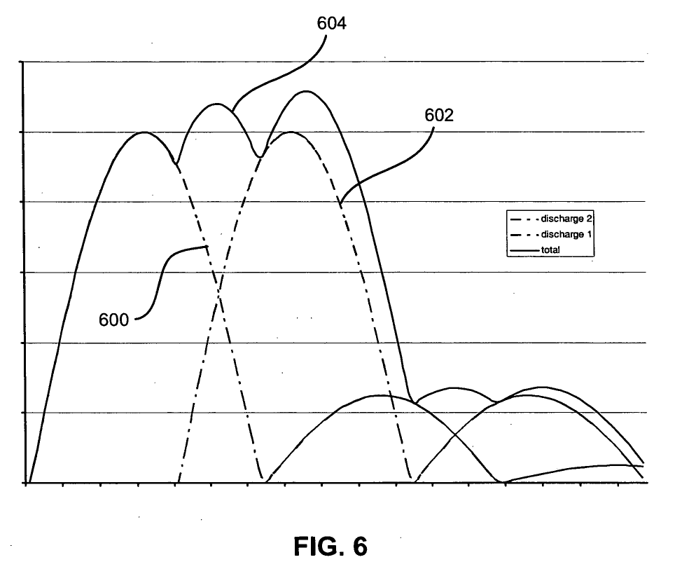

The stretching of the overall pulse can be a result of the superimposition of gain in the gas medium as a result of the separated discharges. A delay between discharges on the order of about 20 ns, for example, can provide for some “overlapping” of the gain produced by each pulse such that a lengthened gain period is introduced into the gas medium. The temporal separation, or delay, between discharges should be greater than 0 sec in order to stretch the output pulse and lower the output peak power, but less than the temporal duration of one of the discharges, in order to ensure some temporal overlap of the separate pulses. The temporal overlap is necessary to ensure that a single, stretched pulse is generated instead of a plurality of relatively short pulses. The overlap also can be selected such that the overlap of the pulses creates a more uniform peak intensity, as will be described with respect to FIG. 6.

Further, a proper combination of capacitor and inductor values used to set the relative timing of the discharges can help to reduce acoustic waves and shock waves in the laser chamber, especially for repetition rates above 4 kHz. Any discharge in the laser gas can produce acoustic and/or shock waves that travel in both directions along the resonator axis. As the discharges are separated temporally and spatially, these waves are less focused and can interfere destructively as they propagate in opposing directions, such that an effective damping of the shock and sound waves occurs. Further, separating the discharge such that each separate discharge has a lower energy dissipation can cause the shock and/or sound waves to have a lower initial intensity, such that less instability is introduced into the laser chamber.

Generating multiple discharge pulses in the resonator chamber, each of which can be controlled in timing, allows for an optimization of the temporal shape of the resulting output laser pulse. Applying the energy to the segmented electrodes rather than to a standard electrode pair also can improve the stability of the gas discharge. This higher stability can be specifically attractive to obtain higher repetition rates. Separated electrode segments can be used with laser systems of any appropriate wavelength, and can be used for applications such as microlithography where an optimization of the laser pulse length is desirable. The use of electrode segments also can be beneficial for high repetition rate lasers and high power level lasers.

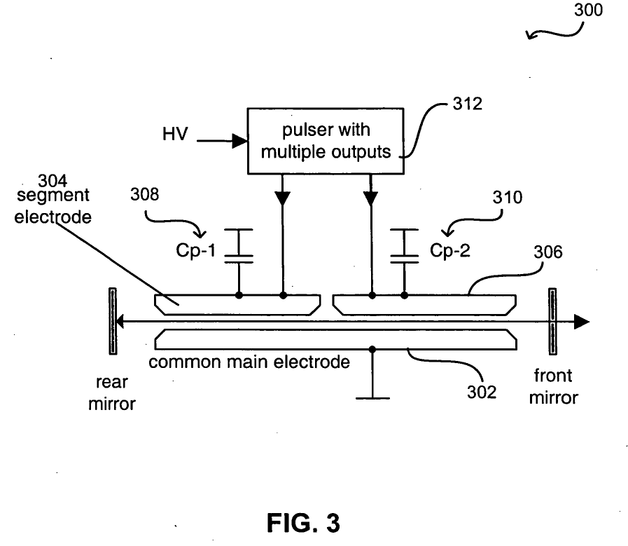

FIG. 3 shows a laser system 300 in accordance with another embodiment of the present invention. The anode is again separated into two segments 304, 306 while the cathode 302 remains un-segmented. In this embodiment, however, a solid state pulser module 312 is used that provides separate output pulses, with each of these output pulses being directed to the appropriate anode segment. A common pulser that can be used in accordance with such an embodiment is described in U.S. Pat. No. 6,005,880, entitled “PRECISION VARIABLE DELAY USING SATURABLE INDUCTORS,” issued Dec. 21, 1999, hereby incorporated herein by reference. Such a split output common pulser module can provide accurate sub-nanosecond timing control between the voltage branches of an excitation circuit that are driven by a common switch, allowing for the introduction of variable timing delays between branches of the circuit and eliminating relative timing jitter. Saturable inductors can be used with variable bias in the high-voltage excitation circuit, providing a continuously tunable delay on the sub-nanosecond time scale between two or more excitation circuit branches. The common pulser module 312 can split the current prior to the last compression stage, such that the individual pulses are decoupled before being delivered to the electrode segments 304, 306. In this embodiment the voltage hold-off time of the last compression stage can determine the timing of the respective electrode voltage signal, which then leads to the gas discharge. The voltage hold-off of a typical compressor stage is on the order of about 100 ns and is determined by the characteristics of the magnetic core of the appropriate inductor, as well as the number of windings on the core and the applied voltage. Proper selection of the voltage hold-off can provide a fixed delay between the two pulses. In a practical case the shift in delay between the two pulses can be set to about 20 ns. As a result the inversion in the later segment of the discharge volume can be built up at a later time. The peak of the inversion can be reduced while the duration over which sufficient inversion is obtained is extended in time.

A long pulse with low peak power can be desirable for applications such as microlithography where damage to downstream optics can be avoided and/or lessened, and the compaction effect in fused silica can be reduced. A longer pulse also can facilitate line narrowing used for microlithography lasers, and can significantly reduce the amount of amplified spontaneous emission (ASE). Performance at the high repetition rate can be improved by the enhanced stability of the discharge. The use of multiple electrode segments also can affect the spatial distribution of the laser discharge, as the multiple discharges can enable modulation of the effective gain length. A reduction in the effective gain length can be used to further reduce the ASE level of the laser, as the ASE level emitted by an excimer laser typically is relatively high prior to formation of the lasing pulse. The ASE level can drop significantly in the presence of the laser pulse. In order to reduce the ASE during the start of the laser pulse, the effective gain length and the inversion can be reduced during the initial phase of the pulse.

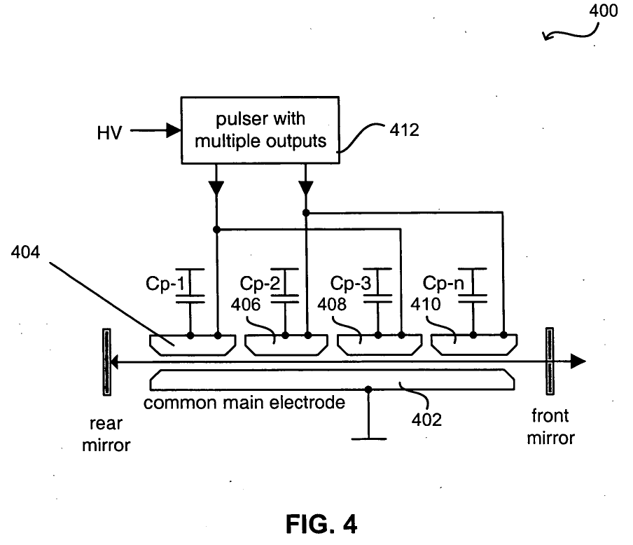

FIG. 4 shows a laser system 400 in accordance with another embodiment of the present invention. This embodiment uses a split common pulser module 412 and a single cathode 402 as in the system of FIG. 3. In this embodiment, however, the anode is segmented into four electrode segments 404, 406, 408, 410. The two decoupled outputs from the pulser module 412 can be connected to apply essentially the same voltage pulse to alternating electrode segments, such as a first output applied in parallel to segments 404 and 408 and a second output applied in parallel to segments 406 and 410, with each segment utilizing an individual peaking capacitor. This can help to distribute the load more evenly along the resonator axis in the discharge chamber. The number of segments and the number of separated pulser outputs can be varied by embodiment, such as a system with two voltage outputs going to six alternating segments or with three outputs going to six alternating segments. Alternatively, three or more outputs could each go directly to three or more electrode segments. The number of electrode segments and/or voltage outputs can be optimized for the specific system and/or application. The parallel operation of specific electrode segments driven from the same output allows for further optimization of the temporal and spatial modulation of the gain, which can further optimize laser performance.

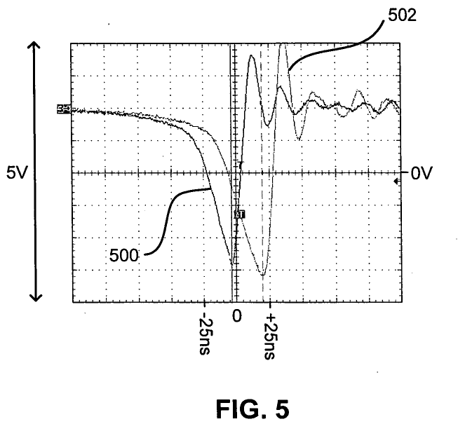

FIG. 5 shows discharge voltage curves 500, 502 for each of the separated discharges, such as for the system of FIG. 2 which utilizes two electrode segments for the anode. In this example there is a timing delay of about 23 ns between peak voltage pulses. The delay of the voltage pulses was determined primarily by the parameters of the final compressor. The main coupling of the electrical power into the gas volume occurs during the period of each curve where the discharge voltage curve shows the first steep positive slope. Some energy is still dissipated during the first and second ringing of the voltage signal. The delay of about 20 ns to 25 ns appears to be favorable if a long pulse shape is desired. The electrical power coupled into the gas and the resultant inversion of the laser cannot be measured directly.

FIG. 6 illustrates the effect of the separated, delayed discharges on the resultant temporal shape of the inversion. Curve 600 shows the estimated current for the first discharge, while curve 602 shows the estimated current for the second discharge. The intensity of each of the curves is less than the intensity of a corresponding single curve (where, for instance, both discharges occur at the same time such that the two curves substantially completely overlap). Curve 604 shows the superimposition of both curves, where the effect of the superimposition on the temporal shape of the inversion can be seen. As discussed above, the relative delay between discharges should be large enough that a sufficient pulse stretching and/or peak power reduction is obtained. The relative delay also should be less than the temporal duration of one of the peak pulses, in order to avoid a separation of the pulses and to ensure at least some overlap of the pulses. As shown in FIG. 6, it can be desirable that the delay be set such that the superimposed peak of curve 604 between the main peaks of curves 600 and 602 be of approximately the same intensity as those main peaks. This provides for a more uniform discharge between the main peaks. As the delay increases from this point, the pulse can be stretched but the uniformity can decrease. As the delay decreases from this point, the pulse will not be as stretched, and the peak intensity will increase. As the number of superimposed curves increases, such as for additional discharges and/or voltage pulses, the resultant superimposed curve can approach a pulse with a substantially flat top as known in the art, which can be significantly more stable than a single pulse.

Pre-Ionization

One way to improve the stability of a discharge in an excimer or molecular fluorine laser system 700 is to utilize some means of laser gas pre-ionization 702. Means of pre-ionization are discussed, for example, in U.S. patent application Ser. No. 10/776,137, entitled “EXCIMER OR MOLECULAR FLUORINE LASER WITH SEVERAL DISCHARGE CHAMBERS,” filed Feb. 11, 2004, hereby incorporated herein by reference. Pre-ionization can create a sufficient amount of free electrons and ions in the laser gas to provide for a substantially homogeneous avalanche discharge. In commercial excimer lasers, for example, a corona discharge or spark-UV-pre-ionization can be used to pre-ionize the gas. Placement of the pre-ionizing elements homogeneously to the main discharge can lead to a stable, homogeneous gas breakdown. The pre-ionization can be used to determine the timing of at least one of the discharges in a segmented electrode system, as well as the breakdown voltage. In one embodiment the pre-ionization pulse is applied prior to the arrival of a discharge voltage. The corona discharge can be driven by the same voltage pulse applied to the main electrodes.

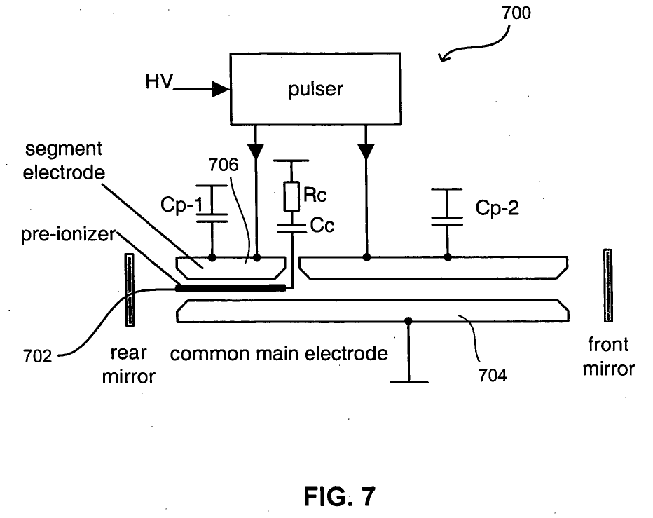

Pre-ionization also can be obtained using UV-laser radiation, such as radiation of a wavelength on the order of about 193 nm. Pre-ionization can be applied to each separated discharge, or can be applied only to one of the separated discharges as shown in FIG. 7 to be applied between cathode 704 and anode segment 706. It also is possible to use the first discharge as a source of pre-ionization for any subsequent discharges. Once the first electrode segment has discharged, the (UV) laser beam can pass through the discharge volume of the second electrode segment. The laser beam can generate a sufficient level of free electrons and ions in the discharge volume of the second electrode segment that can consequently discharge. This arrangement is similar to spiker-sustainer excitation circuits as known in the art.

An electronic control module can be used to control the timing of a trigger ionization of gases between at least one pair of segmented electrodes. By controlling this trigger ionization, the precise timing of the actual discharge(s) can be more finely controlled. Each ionization control can include, for example, a high voltage (HV) power supply or high voltage pulse generator in electrical communication with an ionization element or electrode 702. There can be a single ionization pulse generator, or one pulse generator for each ionization element. Other ionization configurations are possible, such as separate ionization circuits in series with a high frequency transformer, multiple such circuits in series, or a single such circuit, in order to obtain the appropriate voltage. Proper ionization of the gas can produce a sufficient level of electrons, ions, and charged particles to start an avalanche gas discharge in the entire volume of a discharge gap.

Ensuring sufficient ionization can provide for a “fine” control over the timing of a discharge. Firing an ionization pulse after the electrodes or electrode segments are charged can ensure that the actual discharge occurs with a controlled timing or delay. Even if the charging of the electrodes can vary on the order of about 10 ns, the trigger ionization can be fired after this period of potential variation in order to more accurately control the timing of each discharge. Since the timing of the ionization pulse can be controlled to within about 1 ns, the timing of the discharge then also can be controlled to within 1 ns even if the charging of the main electrodes varies by 10 ns. The ionization can be used to adjust the delay between electrode segments. In an exemplary approach, the ionization can be obtained using a corona discharge component that provides sufficient ionization after arrival of the main voltage pulse. The design and configuration of a corona rod used for trigger ionization in accordance with various embodiments of the present invention can utilize any of a number of corona rod configurations that are presently used in conventional pre-ionization approaches, such as described in U.S. patent application Ser. No. 10/696,979, filed Oct. 30, 2003, entitled “MASTER OSCILLATOR—POWER AMPLIFIER EXCIMER LASER SYSTEM,” hereby incorporated herein by reference. The result of this ionization is a precise timing of the gas breakdown close to the point where the peaking capacitors are charged to a maximum voltage.

The circuitry for the trigger ionization can be separated from the circuitry for the main discharge pulse, such that the timing of the ionization can be controlled independently. The discharges can be synchronized to a higher accuracy than in existing systems, provided that the trigger ionization pulse timing is more precisely controlled than the timing of the main voltage pulse. An advantage of such an approach lies in the fact that requirements on the timing of the main discharge voltage pulse can be greatly reduced. The switching of the ionization can require a fairly low amount of power, such as on the order of tens of Watts or less, such that a fast pulsed source of high voltage can be used without multiple stages of compression and the associated delay uncertainty. Such a circuit can have sufficiently low inductivity and stray capacity, however, in order not to produce displacement current through the corona rod as the voltage on the main discharge electrode rises.

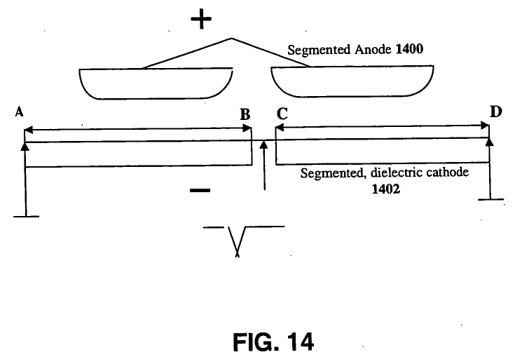

In one embodiment an effective preionization energy can be obtained for a discharge of at least one of the segmented electrodes using a “plasma cathode” arrangement as known in the art, such as the arrangement shown in FIG. 14. The cathode in a plasma cathode arrangement is a dielectric, such that when a voltage is applied across the electrodes a plasma is formed along the surface of the dielectric cathode (shown along the surface of the cathode marked A-B and C-D). In accordance with embodiments of the present invention, the anode 1400 and dielectric cathode 1402 can be segmented as described elsewhere herein. The formation of a plasma along the surface of the dielectric cathode can help to stabilize the discharge, such that a higher efficiency can be obtained. Longer pulses and higher repetition rates also are possible once the discharge is sufficiently stable. In one system using a dielectric cathode such as shown in FIG. 14, the length of distances A-B and C-D is no more than 8 cm in length, with a corresponding cathode width of no more than 2 mm.

Beam Dimension

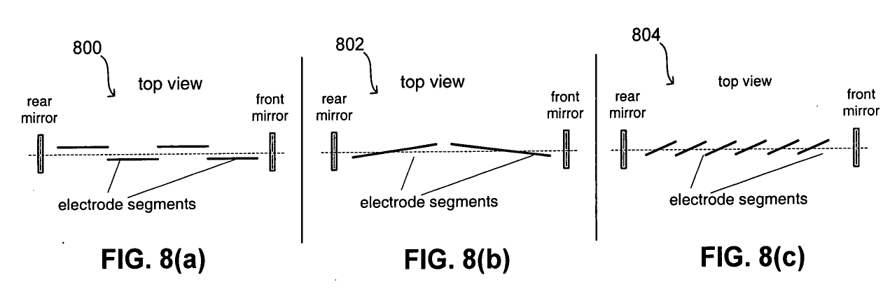

For various applications it is necessary to have a relatively high power laser beam, while it is desirable to have the energy density and/or power density of the beam relatively low in order to minimize the damage to the optics within, and external to, the laser. One way to obtain these levels is to optimize the geometric arrangement of the electrode segments. The segmented electrodes described above can be arranged in any of a number of different configurations, such as those shown in FIGS. 8(a)-8(c), with the arrangement in x, y, and z directions being dependent upon a number of factors. For example, the x- and z-directions can be determined by the gas exchange requirements of the discharge volume between laser pulses. High repetition rate lasers of 4 kHz and higher can have a narrow x- and/or z-dimension in order to obtain the proper gas clearing at a reasonable gas velocity, such as a velocity on the order of about 30-50 m/s. In one arrangement 800 such as that shown in the top view of FIG. 8(a) where the upper electrode (here the anode) is segmented, the alignment of the anode segments can be parallel but offset in the x-direction. The offset can be alternating, as shown, or can be any other appropriate variation within a discharge region of the laser system. The corresponding cathode (not shown but underlying the anode segments in the Figure) can be a single electrode running along the resonator axis below the anode segments, or can be segmented and/or oriented to match the anode segments.

The anode segments also can be at an angle with respect to each other and/or with respect to the resonator axis. For example, the arrangement 802 of FIG. 8(b) shows two anode segments with opposite angles (with respect to the resonator axis), while the arrangement 804 of FIG. 8(c) shows six anode segments at the same angle relative to the resonator axis. As discussed with respect to FIG. 8(a), the corresponding cathode (not shown but underlying the anode segments in the Figure) can be a single electrode running along the resonator axis (below the anode segments in the Figure), or can be segmented and/or oriented to match the anode segments. In a practical case having a discharge width of 3 mm at FWHM, the offset and/or angled width of the segments can be on the same order of about 3 mm. As the offsetting of angle increases, the width of the beam increases and the energy density of the beam decreases. With an offsetting, there also can be a wider output beam and/or a more narrow discharge on each individual segment. Depending on the application, it may be feasible to align certain segments of the electrodes or to arrange the segments all in a shifted position. Other arrangements of the electrodes can allow for an optimization of gas flow characteristics and acoustic damping.

For applications where the gain length of the laser is of less importance than the total gain, this approach can allow a beam to be extracted with increased x-dimension and, thus, reduced energy density. The discharge width can remain small for each of the segments, and the gas clearing requirements can still be met. The use of segment electrodes also allows for different spacing between segments. The electrode spacing can be used to optimize the breakdown voltage of the gas and the performance of the laser. The technique also can be used to generate separated output pulses.

Separation of the Pulses

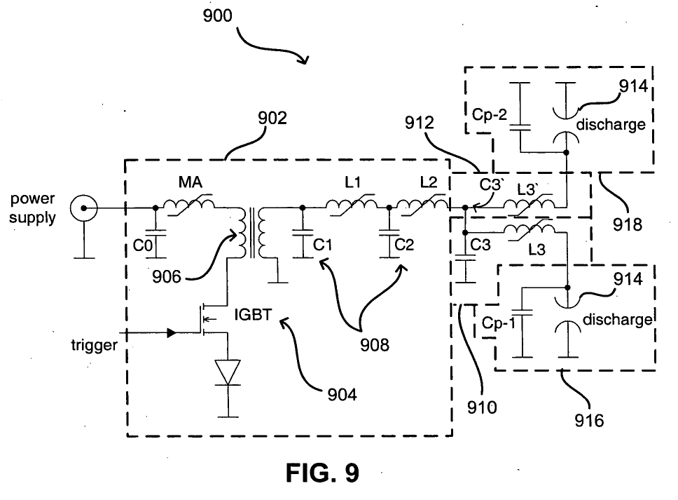

In order to generate decoupled output pulses from a common high voltage source, a solid state pulser module can be used, such as is described in U.S. patent application Ser. No. 10/699,763, entitled “EXCIMER OR MOLECULAR FLUORINE LASER SYSTEM WITH PRECISION TIMING,” filed Nov. 3, 2003, which is hereby incorporated herein by reference. As shown in FIG. 9, the laser system 900 can include a common solid state pulser module 902 including an IGBT switch 902, a transformer 906, and at least one compressor stage 908 that are common to each output pulse. The laser system also can utilize separate final compression stages 910, 912 for each output pulse provided to one of the electrode segments and the associated individual peaking capacitors attached thereto, in order to properly decouple the pulses. The final compression stages can apply the separate timed pulses to the corresponding segments of the segmented main discharge electrode (here the anode) in the gas discharge chamber. For simplicity in the circuit diagram, the gas discharge chamber is shown in separate portions, a first portion 916 including the first anode segment capable of discharging relative to a first portion of the cathode electrode, and a second portion 918 including the second anode segment capable of discharging relative to a second portion of the cathode electrode, as a single cathode 914 is used in the gas discharge chamber for each pulse/discharge. The layout of the final compressor stages can determine the hold-off time for each voltage pulse. Each final compressor stage can include an inductor having a magnetic core, of an appropriate core material such as a Finemet type amorphous magnetic alloy, with an appropriate number of windings. This circuit diagram may better be understood when viewed in conjunction with FIGS. 2 and 3. In FIG. 2, the common pulser module 212 includes components which are common to both electrode segments 204, 206, but outputs the voltage pulse to separate final compression stages. Here, the first final compression stage includes capacitor 208 and inductor 214 while the second final compression stage includes capacitor 210 and inductor 216. In FIG. 3, the final compression stages still can be separate but included in the split pulser module 312, whereby the split pulser module directly outputs first and second voltage pulses directly to the first electrode segment 304 and second electrode segment 306.

A reset current can be applied to the inductor of each final compression stage 910, 912 in order to provide accurate sub-nanosecond timing control between the voltage outputs for each voltage pulse path, or channel, as driven by the common pulser. The basic approach to introducing variable timing delays between branches or channels of a circuit is described in U.S. Pat. No. 6,005,880, entitled “PRECISION VARIABLE DELAY USING SATURABLE INDUCTORS,” incorporated herein by reference above. Using such an approach with a common pulser system, a reset current component for each channel can apply a separate reset current to the final inductor of each final compressor stage, which can function as a tuning component for the main discharge pulse of each channel. The reset current applied can be determined using a computer or processing component in combination with a mechanism for monitoring the timing of the discharges.

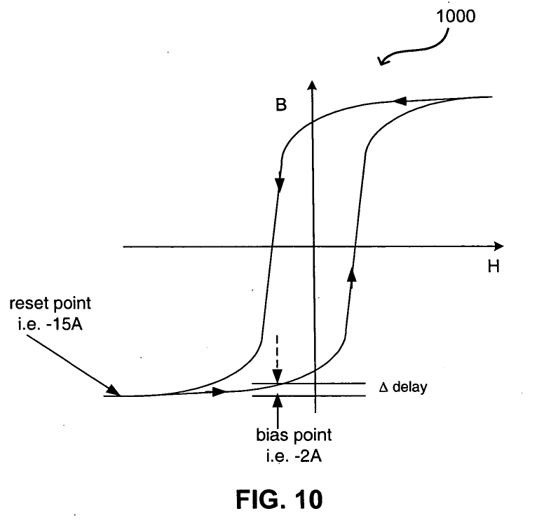

In one embodiment, a reset current supplied to one or both of the final compressor stages can be used to adjust the delay of the corresponding circuit loop. Controlling the individual delay to the final compressor stage for each channel of the system can provide a control of the delay of the output pulse from each final compressor stage. FIG. 10 shows an exemplary magnetization curve 1000 for the compressor core material. The reset current can be used in a solid state pulser to reset the magnetic assist and pulse compressors to a defined state of magnetization. The time integral of the voltage drop V(t) on the saturable inductor is proportional to the total flux, as given by:
∫V(t)·dt=N·A·ΔB
where V(t) is the applied voltage, N is the number of winding turns, A is the magnetic core cross sectional area, and ΔB is the magnetic flux density swing. For a square voltage pulse the saturation time is given by

$${τ}_{sat} = \frac{N \cdot A \cdot Δ B}{V}$$

In an exemplary setup, the magnetic core of a final compressor has 4 turns and an operating voltage of 30 kV, whereby the saturation time is on the order of about 100 ns. The number of turns of the inductor of the final compression stage can be selected to adjust the saturation time as needed. For example, the use of five windings instead of four windings can lead to a suitable shift in the delay of about 25 ns.

The saturation flux density Bₛₐₜ can be reached faster if the core is not completely reset before the pulse to—Bₛₐₜ. Reasons for variation in the magnetization between pulses can include fluctuations in the reset current, variations in the time between pulses in the burst mode, and magnetization by “reflected” pulses. For each switching cycle, the core can be driven through the magnetization curve, where the pulser current drives the magnetic material into positive saturation and the reset current drives the core back to a defined point on the magnetization curve.

The exact position to which the core is reset on the magnetization curve can be a function of the reset current. With higher magnetization, the magnet will take longer to saturate, such that the forward current will encounter a longer delay. The influence of the reset current on the pulser delay has been found to be several nanoseconds per ampere of reset current. This makes feasible a modulation of the resulting pulser hold-off delay by fine adjustment of the reset current. The reset current can be used to adjust the nominal delay difference between the two discharges. For a stable laser operation in certain embodiments, the difference in the delay of the two discharges is critical and must be stable within 1 ns.

The timing between the multiple discharges can be further controlled by modulating the saturation time for at least one of the inductor cores in the compressor stage(s) of the common pulser module. In order to modulate the saturation time, an additional voltage can be superimposed onto the operating voltage. Once the start condition of the core is reached by applying a reset current, the additional voltage can be applied before the operating voltage. The additional voltage then can begin to pull magnetic flux from the core in order to drive the core towards the saturation point. Using a relatively low voltage on the order of about 10V can lead to a longer saturation time, such as on the order of about 300 μs. Application of this additional voltage for a controlled time prior to the application of the main voltage pulse can allow the core to be set to virtually any point on the B-H curve. For example, the saturation time can be reduced by about 20 ns by applying an additional voltage pulse of 10V for approximately 60 μs.

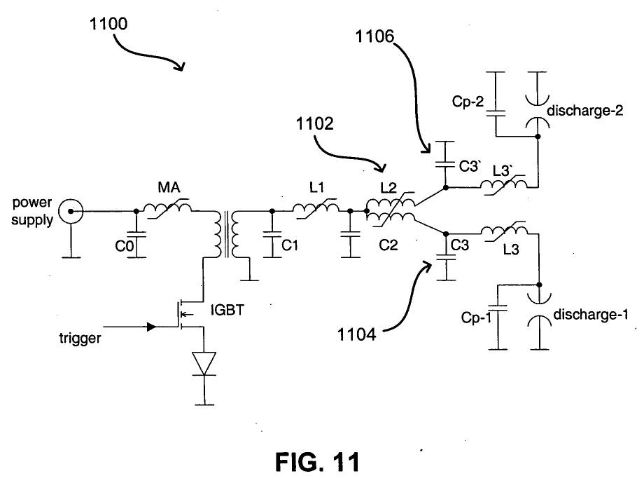

If the timing shift between the output pulses applied to the various electrode segments becomes sufficiently large with respect to the saturation time, the final discharge pulse can compete for energy. It therefore can be desirable to utilize additional decoupling of the circuits, which can be achieved in at least one embodiment by splitting the winding of the last common compressor core 1102 of the system 1100 as shown in FIG. 11. After the split, individual capacitors 1104, 1106 can be used for each electrode segment, or at least each separated pulse to be sent to a number of electrode segments. The splitting of the a compressor core also can be applied to other inductors of the common pulser module, which then can utilize separate transfer capacitors downstream in the circuit.

MOPA Systems

Excimer lasers used in lithography often should be line-narrowed, and should work with high repetition rates above 1 kHz and energy levels between 5-15 mJ. The length of a single laser pulse can be of great importance for such lasers, especially for wavelengths below 193 nm. The short pulses can have a high peak power, which can severely damage the optics of the laser or of a scanner, stepper, etc. MOPA systems can be used to address this problem, as MOPA technology can separate the bandwidth and power generators of a laser system, as well as to control each gas discharge chamber separately, such that both the required bandwidth and pulse energy parameters can be optimized. Using a master oscillator (MO), for example, an extremely tight spectrum can be generated for high-numerical-aperture lenses at low pulse energy. A power amplifier (PA), for example, can be used to intensify the light, in order to deliver the power levels necessary for the high throughput desired by the chip manufacturers. The MOPA concept can be used with any appropriate laser, such as KrF, ArF, and F₂-based lasers.

Components of one MOPA laser system are discussed generally in U.S. patent application Ser. No. 09/923,770, filed Aug. 6, 2001, hereby incorporated herein by reference, which discloses a molecular fluorine (F₂) laser system including a master oscillator (or seed oscillator) and power amplifier. The master oscillator comprises a laser tube including multiple electrodes therein, which are connected to a discharge circuit. The laser tube is part of an optical resonator for generating a laser beam including a first line of multiple characteristic emission lines around 157 nm. The laser tube can be filled with a gas mixture including molecular fluorine and a buffer gas. The gas mixture can be at a pressure below that which results in the generation of a laser emission, including the first line around 157 nm having a natural line width of less than 0.5 pm, without an additional line-narrowing optical component for narrowing the first line. The power amplifier increases the power of the beam emitted by the seed oscillator to a desired power for applications processing. A power amplifier (PA) typically includes a discharge chamber filled with a laser gas, such as a gas including molecular fluorine, and a buffer gas. Electrodes positioned in the discharge chamber are connected to a discharge circuit, such as an electrical delay circuit, for energizing the molecular fluorine in the chamber. The discharge of the PA can be timed to be at, or near, a maximum in discharge current when a pulse from the master oscillator (MO) reaches the amplifier discharge chamber. Various line-narrowing optics can be used, such as may include one or more tuned or tuneable etalons.

In a MOPA, the oscillator can produce narrow-band pulses with low energies, such as on the order of about 1-2 mJ, and the amplifier can amplify the pulses to pulse energies on the order of about 10-15 mJ. MOPA arrangements can be used with XeCl excimer lasers, for example, which can be used for thin film transistor (TFT) annealing, where annealing energies of above 1 J can be necessary and the stability σ can be under 1%. One potential problem with existing MOPA configurations is that the optics in the amplifier (and any subsequent scanner/stepper) can be damaged as the pulse exiting the amplifier of a typical MOPA system is short but intense, having a relatively high energy level. It can be difficult to obtain effective pulse stretching in a standard MOPA system, as it can be difficult to produce the necessary high repetition rates (>4 kHz).

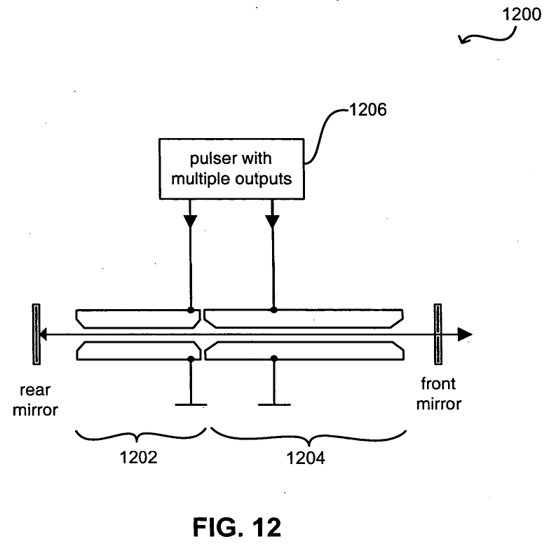

In various MOPA systems, it can be advantageous to utilize pulse stretching as discussed herein for the power amplifier chamber. Other systems can utilize pulse stretching with the master oscillator chamber, or with both chambers. Another possible configuration for a MOPA system 1200 in accordance with one embodiment of the present invention is shown in FIG. 12, which utilizes a single chamber design for a MOPA system. The main discharge electrodes of the chamber are segmented into an oscillator set 1202 and an amplifier set 1204. In such an arrangement, a common pulser module 1206 as described above can be used to apply a first pulse to the oscillator electrode set in order to generate an optical pulse in the laser gas therebetween, and can apply a delayed second pulse to the amplifier electrode set in order to amplify the generated optical pulse. The delay between the oscillator set 1202 and amplifier set 1204 can be on the order of about 15-50 ns, and can be obtained through separation of the last pulse compressor stage as described above. As seen in the Figure, the oscillator electrode segments 1202 can be shorter than the amplifier electrode segments 1204. The ratio of the length of the oscillator electrode to the length of the amplifier electrode can be in the range of from about 1:5 to about 1:10. Such a configuration can obtain 20% more energy from the amplifier set compared to a standard resonator. Further, the energy that needs to be supplied to the oscillator electrode segments the seeding of the amplifier can be relatively low, such as on the order of about 1-3 mJ, such that it is possible to work under saturation. Working under saturation can help to improve the stability of the output beam. Further, the service and handling of a single chamber MOPA configuration can be significantly easier and less expensive. The oscillator can have a long resonator, due to the inclusion of the amplifier electrode set, and for this reason the beam quality may not be optimal for certain applications.

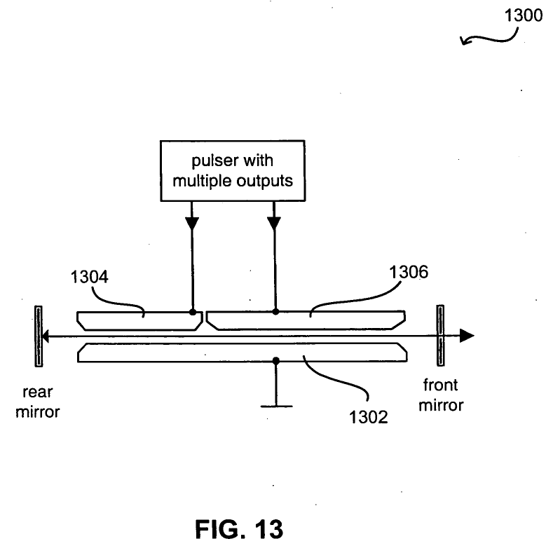

FIG. 13 shows a system 1300 in accordance with another embodiment, which uses a single cathode electrode 1302 for a single chamber MOPA arrangement as described with respect to FIG. 12. The anode electrode is segmented into an oscillator segment 1304 and an amplifier segment 1306. As shown, the oscillator segment still can be shorter than the amplifier segment. Using a single cathode electrode can simplify the overall design, while still obtaining the favorable results of a single chamber MOPA system.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

1. A gas discharge laser system including:
a gas discharge chamber filled with a gas mixture and having a first main discharge electrode and a second main discharge electrode disposed therein, the first main discharge electrode including a first electrode segment and a second electrode segment; and
a pulse compression circuit coupled with the first electrode segment and the second electrode segment, the pulse compression circuit operable to apply a first voltage pulse to the first electrode segment at a first time and a second voltage pulse to the second electrode segment at a second time, the second time having a delay with respect to the first time, whereby the first voltage pulse causes a first discharge and the second voltage pulse causes a second discharge in the gas mixture, the first and second discharges operating to output an optical pulse.

2. A laser system according to claim 1, wherein:
the pulse compression circuit includes a pulser module for generating an output voltage pulse, the pulse compression circuit including a node for receiving the output voltage pulse and separating the output voltage pulse into the first and second voltage pulses.

3. A laser system according to claim 2, wherein:
the pulse compression circuit further includes at least one final compression stage between the node and the first electrode segment and at least one final compression stage between the node and the second electrode segment.

4. A laser system according to claim 1, wherein:
the pulse compression circuit includes a pulser module capable of outputting the first and second voltage pulses.

5. A laser system according to claim 2, wherein:
the pulse compression circuit further includes a first final compression stage for applying the first voltage pulse to the first electrode segment and a second final compression stage for applying the second voltage pulse to the second electrode segment.

6. A laser system according to claim 1, wherein:
the delay is in the range of about 10 ns to about 30 ns.

7. A laser system according to claim 1, wherein:
the delay is less than a temporal duration of the first and second voltage pulses, such that there is some overlap between the first and second pulses.

8. A laser system according to claim 2, wherein:
the pulse compression circuit includes a reset current unit capable of applying a reset current an inductor of the pulse compression circuit in order to adjust the delay.

9. A laser system according to claim 2, wherein:
the pulse compression circuit includes a preionization unit capable of applying a preionization voltage to the gas mixture before the first discharge in order to further control the delay.

10. A laser system according to claim 1, wherein:
the pulse compression circuit can increase the delay in order to lengthen the optical pulse.

11. A laser system according to claim 1, wherein:
the pulse compression circuit can increase the delay in order to lower a peak value of the optical pulse.

12. A laser system according to claim 1, wherein:
the pulse compression circuit is operable to increase the delay in order to improve a peak uniformity of the optical pulse.

13. A laser system according to claim 1, wherein:
the second main discharge electrode is non-segmented.

14. A laser system according to claim 1, wherein:
the first main discharge electrode further includes third and fourth electrode segments.

15. A laser system according to claim 14, wherein:
the first and third electrode segments are connected in parallel to a first voltage output channel of a pulser module of the pulse compression circuit and the second and fourth electrode segments are connected in parallel to a second voltage output channel of the pulser module, in order to apply the first voltage pulse to the first and third electrode segments and the second voltage pulse to the second and fourth electrode segments.

16. A laser system according to claim 1, wherein:
the first electrode segment is offset with respect to the second electrode segment.

17. A laser system according to claim 1, wherein:
the first electrode segment is angled with respect to the second electrode segment.

18. A laser system according to claim 1, wherein:
the gas discharge chamber has a resonator axis, and each of the first and second electrode segments is at an angle with respect to the resonator axis.

19. A laser system according to claim 1, wherein:
the pulse compression circuit includes a first final compression stage for the first voltage pulse and a second final compressor stage for the second voltage pulse, in order to decouple the first and second voltage pulses.

20. A laser system according to claim 1, wherein:
the first segment and second main discharge electrode function as an oscillator to generate an optical pulse with the first discharge, and the second segment and second main discharge electrode act as an amplifier to amplify the optical pulse with the second discharge.

21. A laser system according to claim 1, wherein:
the first main discharge electrode is an anode electrode and the second main discharge electrode is a cathode electrode.

22. A laser system according to claim 1, wherein:
the first main discharge electrode is a cathode electrode and the second main discharge electrode is an anode electrode.

23. A gas discharge laser system including:
a gas discharge chamber filled with a gas mixture and having a first main discharge electrode and a second main discharge electrode disposed therein, the first main discharge electrode including a first electrode segment and a second electrode segment;
a pulse compression circuit having a single voltage output and operable to apply a timed voltage pulse to the single voltage output; and
a first inductor coupling the single voltage output to the first electrode segment and a second inductor coupling the single voltage output to the second electrode, the first and second inductors having different inductance values such that the timed voltage pulse reaches the first electrode segment at a first time and the second electrode segment at a second time, the second time having a delay with respect to the first time, whereby the timed voltage pulse causes a first discharge from the first electrode segment and a second discharge from the second electrode segment, the first and second discharges operating to output an optical pulse.

24. A laser system according to claim 23, further comprising:
a first capacitor coupled to the first electrode segment and a second capacitor coupled to the second electrode segment, the first and second capacitors capable of storing a charge to be discharged into the gas medium.

25. A gas discharge laser system including:
a gas discharge chamber filled with a gas mixture and having a first main discharge electrode and a second main discharge electrode disposed therein, the first main discharge electrode including a first electrode segment and a second electrode segment;
a pulse compression circuit having a first voltage output for applying a first voltage pulse to the first electrode segment at a first time and a second voltage output for applying a second voltage pulse to the second electrode segment at a second time, the second time having a delay with respect to the first time, whereby the first voltage pulse causes a first discharge from the first electrode segment and the second voltage pulse causes a second discharge from the second electrode segment, the first and second discharges operating to output an optical pulse.

26. A method for use in a gas discharge laser system, the gas discharge laser system including a gas discharge chamber filled with a gas mixture and having at least a first main discharge electrode and a second main discharge electrode disposed therein, the first main discharge electrode including a first electrode segment and a second electrode segment, the method comprising the steps of:
applying a first voltage pulse at a first time to the first electrode segment in order to cause a first discharge in the laser gas; and
applying a second voltage pulse at a second time to the second electrode segment in order to cause a second discharge in the laser gas, the second time having a delay with respect to the first time, the first and second discharges operating to output an optical pulse.

27. A method according to claim 26, further comprising:
adjusting the delay in order to control a length of the optical pulse.

28. A method according to claim 27, wherein:
adjusting the delay varies the delay in the range of from about 10 ns to about 30 ns.

29. A method according to claim 27, wherein:
adjusting the delay varies the delay in the range from 0 ns to a temporal duration of the first and second discharges.

30. A method according to claim 26, further comprising:
adjusting the delay in order to lower a peak value of the optical pulse.

31. A method according to claim 26, further comprising:
adjusting the delay in order to improve a peak uniformity of the optical pulse.

32. A method according to claim 26, further comprising:
generating the first and second voltage pulses using a pulser module.

33. A method according to claim 26, further comprising:
applying a reset current to an inductor for at least one of the first and second voltage pulses to further adjust the timing and shape of at least one of the first and second voltage pulses.

34. A method according to claim 26, further comprising:
applying a preionization current to the gas mixture before the first discharge in order to further control the timing of the first discharge.

35. A method according to claim 26, wherein the first main discharge electrode further includes third and fourth segments, further comprising:
applying the first voltage pulse to the first and third segments and applying the second voltage pulse to the second and fourth segments.

36. A method according to claim 26, further comprising:
offsetting the first electrode segment with respect to the second electrode segment.

37. A method according to claim 26, further comprising:
angling the first electrode segment with respect to the second electrode segment.

38. A method according to claim 26, wherein the gas discharge chamber has a resonator axis, further comprising:
angling each of the first and second electrode segments with respect to the resonator axis.

39. A method according to claim 26, further comprising:
decoupling the first and second voltage pulses using a first final compression stage for the first voltage pulse and a second final compressor stage for the second voltage pulse.

40. A method according to claim 26, further comprising:
generating an optical pulse with the first discharge from the first segment and second main discharge electrode, and amplifying the optical pulse with the second discharge from the second segment and second main discharge electrode.
